(19) United States
(12) Patent Application Publication
(10) Pub. No.: US 2016/0048872 A1
(43) Pub. Date: Feb. 18, 2016

(54) SELECTIVELY GENERATING CUSTOMIZED MARKETING CONTENT

(71) Applicant: Pikato, Inc., Chicago, IL (US)

(72) Inventors: Jesus Sanchez, Chicago, IL (US); Weiping Sun, Cambridge (CA); Leonardo Guim, Tampa, FL (US)

(73) Assignee: PIKATO, INC., Chicago, IL (US)

(21) Appl. No.: 14/823,494

(22) Filed: Aug. 11, 2015

Related U.S. Application Data
(60) Provisional application No. 62/036,353, filed on Aug. 12, 2014.

(51) Int. Cl. G06Q 30/02

(52) U.S. Cl. CPC G06Q 30/0255

(57) ABSTRACT

Selectively generating customized marketing content is described. A system identifies a communication device via a communication channel. The system sends a uniform resource locator associated with the communication channel to the communication device. The system generates customized marketing content based on data which includes the identity of the user associated with the communication device, in response to receiving a selection of the uniform resource locator by the communication device. The system sends the customized marketing content to the communication device.

### CLAIM OF PRIORITY

This application claims the benefit of U.S. Provisional Patent Application No. 62/036,353, entitled “PLATFORM FOR GENERATING CUSTOMIZED MARKETING CONTENT ACCESSIBLE FROM A UNIQUE UNIFORM RESOURCE LOCATOR,” filed Aug. 12, 2014, the entire contents of which are incorporated herein by reference.

### BACKGROUND

Electronic advertising has become prevalent for the past decade. However, generating and delivering electronic advertising has been limited in terms of ease of use for end users, such as customers, and marketers. The ability to customize electronic advertisements for customers has also been limited. Using prior art systems, marketers face challenges in delivering real-time, contextually aware, personalized marketing content to customers.

### BRIEF DESCRIPTION OF THE DRAWINGS

FIG. 1 illustrates a block diagram of an example system for selectively generating customized marketing content, under an embodiment;

FIG. 2 is a flowchart that illustrates a computer-implemented method for selectively generating customized marketing content, under an embodiment; and

FIG. 3 is a block diagram illustrating an example hardware device in which the subject matter may be implemented.

### DETAILED DESCRIPTION

Embodiments herein enable selectively generating customized marketing content. A communication device is identified via a communication channel. A uniform resource locator associated with the communication channel is sent to the communication device. Customized marketing content is generated based on data which includes the identity of the user associated with the communication device, in response to receiving a selection of the uniform resource locator by the communication device. The customized marketing content is sent to the communication device.

For example, the system identifies a smartphone in a store via an in-store beacon. The system sends a message, which includes a uniform resource locator, announcing store sales to the smartphone. The system generates customized sales offers for shoes based on data which identifies the user of the smartphone and the user's previously expressed interest in buying shoes, after the user selected the uniform resource locator in the message about store sales. The system sends the customized sales offers for shoes to the user's smartphone.

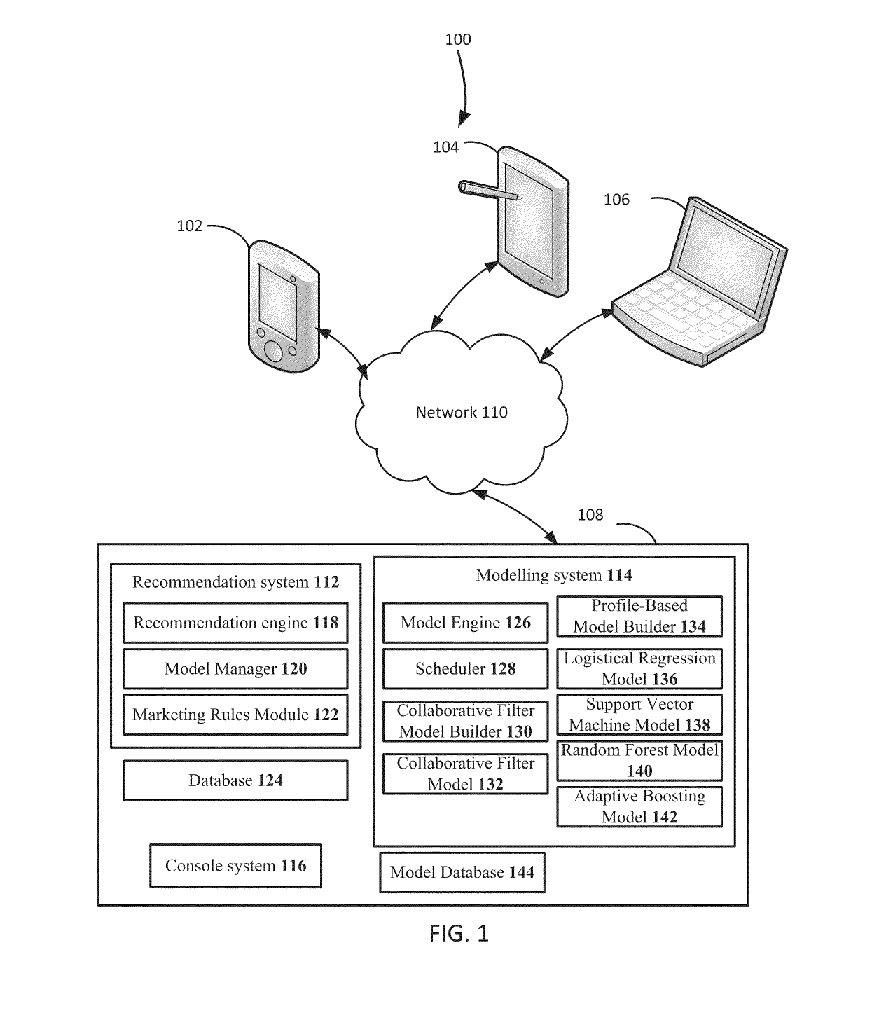

FIG. 1 illustrates a block diagram of an example system 100 for selectively generating customized marketing content, under an embodiment. As shown in FIG. 1, the system 100 may illustrate a cloud computing environment in which data, applications, services, and other resources are stored and delivered through shared data-centers and appear as a single point of access for the end users. The system 100 may also represent any other type of distributed computer network environment in which servers control the storage and distribution of resources and services for different client users.

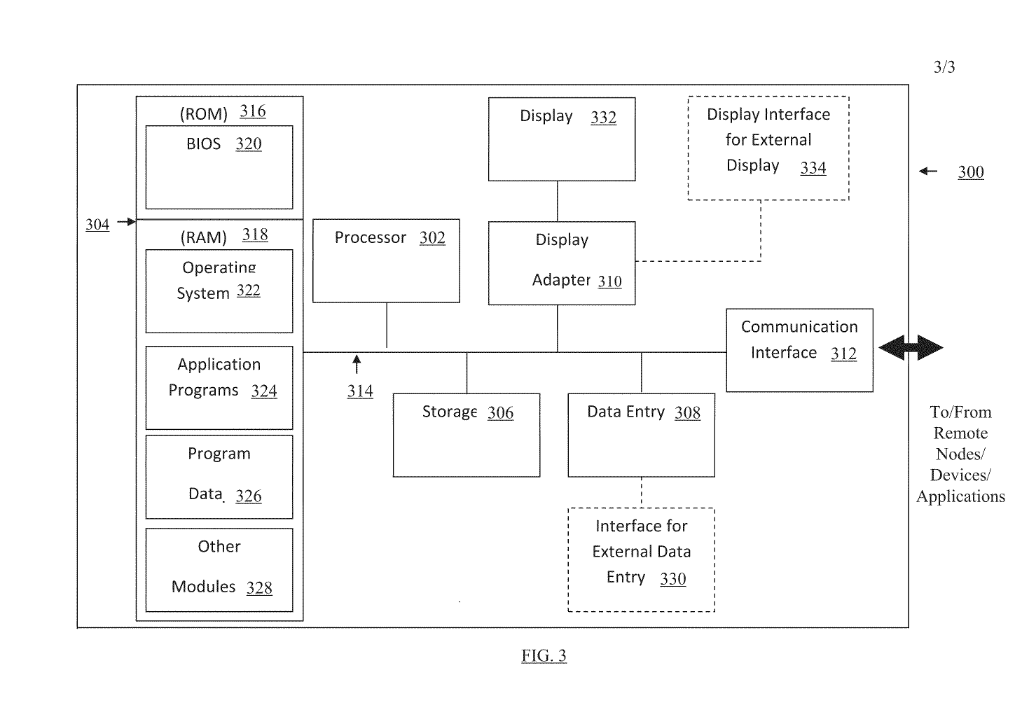

In an embodiment, the system 100 represents a cloud computing system that includes a first communication device 102, a second communication device 104, and a third communication device 106; and a computer system 108 that may be provided by a hosting company. The communication devices 102-106 and the computer system 108 communicate via a network 110. Although FIG. 1 depicts the system 100 with three communication devices 102-106, one computer system 108, and one network 110, the system 100 may include any number of communication devices 102-106, any number of computer systems 108, and any number of networks 110. Although FIG. 1 depicts the first communication device 102 as a smartphone 102, the second communication device 104 as a tablet computer 104, the third communication device 106 as a laptop computer 106, and the computer system 108 as a single computer system 108, each of the system components 102-108 may be any type of computer system. For example, any of the communication devices 102-106 may be a mobile phone, a tablet computer, a laptop computer, a portable computer, a wearable computer. a dual mode handset, a dual subscriber identification module phone, a wireless mobile device, a pager, a personal digital assistant, a digital video player, a digital camera, a digital music player, a digital calculator, an electronic key fob for keyless entry and/or a desktop computer. The system elements 102-108 may each be substantially similar to the hardware device 300 depicted in FIG. 3 and described below. The first communication device 102 may be referred to as a customer's smartphone 102, the second communication device 104 may be referred to as a system administrator's tablet computer 104, the third communication device 106 may be referred to as a marketer's laptop computer 106, and the computer system 108 may be referred to as a marketing system 108. As used herein, the term “marketer” refers to an entity that wishes to provide advertising or offers to a customer, and can include merchants or retailers, but more generally includes anyone who wishes to provide advertising or offers.

The computer system 108 may include a recommendation system 112, a modelling system 114, and a console system 116 which can be an administrative server designed to manage all marketing artifacts and may be accessed by a system administrator via the system administrator's tablet computer 104. Each of the systems 112-116 may be its own separate computer server or combination of multiple computer servers. The recommendation system 112 may include a recommendation engine 118 that makes recommendations based on data associated with a customer, a model manager 120 that calculate scores of advertising offers for a customer based on predictive models, and marketing rules module 122 that enforces eligibility and selection rules. The recommendation system 112 can communicate with the modelling system 114 and a database 124.

The modelling system 114 may include a model engine 126 that coordinates and manages model builders, a scheduler 128 that executes machine learning jobs in specified times, a collaborative filter model builder 130 that builds a collaborative filter model 132, a profile-based model builder 134 that that builds profile based models, such as a logistic regression model 136, a support vector machine model 138, a Random Forest model 140, and an Adaptive Boosting model 142. The scheduler 128 can send the job of building a model to the model engine 126 which coordinates the collaborative filter model builder 130 to build the collaborative filter model 132 and the profile-based model builder 134 to build a profile-based model. The collaborative filter model 132, the logistic regression model 136, the support vector machine model 138, the Random Forest model 140, and the Adaptive Boosting model 142 may be built and trained. The modelling system 114 can retrieve a previous model and its metadata from a model database 144. The modelling system 114 may also retrieve customer information or other information from the database 124. The modelling system 114 can also retrieve relevant information from an external source. The modelling system 114 may persist the trained models and metadata to the model database 144. The modelling system 114 can deliver notifications to the relevant devices/entities that the new or updated models are ready.

A marketer may use the marketer's laptop computer 106 to input information into the marketing system 108. The marketer may input brand information to create a brand, and input global rules to create presentation rules, contact policies, and default rules. The marketer may input page designs and logos to create Hyper Text Markup Language (HTML) pages and an eWallet Pass style. The marketer may input preferences to create preference pages, and input stores and addresses to create stores and geolocations. The marketer may input offer categories information to create offer categories and input offers, metadata, rules, and offer categories to create offers and inclusion/exclusion rules. Then the marketing system 108 uses offers, offer categories, presentation rules, style rules, and other marketing assets to generate a marketing strategy service and uniform resource locators that are integrated with one or many of the touchpoints.

If a customer is a new user of the marketing system 108, then the marketing system 108 may provide a unique user identifier to a communication device associated with the user because the user lacks the unique user identifier required for receiving customized marketing content. For example and without limitation, this may include the marketing system 108 generating a unique user identifier and then providing the unique user identifier to the customer's smartphone 102 because the customer's smartphone 102 had not been registered yet to receive customized marketing content. The customer's smartphone 102 persists the unique user identifier for subsequent use. During the registration process, the marketing system 108 may use the customer's answers to questions to create a customer profile that is unique to the customer.

Once a customer has a unique user identifier, the marketing system 108 may send an option to select from categories associated with marketing content to a communication device. By way of example and without limitation, this may include the marketing system 108 providing marketing interest categories to the customer's smartphone 102, from which the customer can select, such as selecting from an interest in buying shoes and an interest in purchasing apparel.

If marketing interest categories have been provided, the marketing system 108 may receive a selection from categories associated with marketing content from a communication device. In embodiments, this may include the marketing system 108 receiving the selection of shoes as a category of interest from the customer's smartphone 102.

The marketing system 108 identifies a communication device via a communication channel. For example and without limitation, this may include the marketing system 108 identifying the customer's smartphone 102 in a store via one of a department store's many in-store beacons. Continuing this example, the same in-store beacon also identifies the customer's wife's smart phone and the customer's daughter's smartphone because both of these smartphones received and stored their own unique user identifiers when their corresponding smartphone users registered their smartphones with the marketing system 108. Other examples of communication channels include access via a mobile web site, a transmission from an in-store beacon, a Short Message Service (SMS) message from a marketer, a Multimedia Messaging Service (MMS) message from a marketer, a view of an advertisement, a location within a geo-fence, a receipt of a push notification, an execution of a mobile application, a receipt of an email from a marketer, an execution of a local search, a participation in an augmented reality, a scan of a Quick Response (QR) code, a scan of a Universal Product Code (UPC), and an access of a Wi-Fi network. Any of these communication channels can trigger the process which results in selectively generating customized marketing content for a customer.

After identifying a communication device via a communication channel, the marketing system 108 sends a uniform resource locator associated with the communication channel to the communication device. By way of example and without limitation, this may include the marketing system 108 sending a message, which includes a uniform resource locator, announcing the general concept of shoe sales to the customer's smartphone 102 based on data that identifies the customer and the customer's previously expressed interest in buying shoes. Alternatively, the marketing system 108 sends the message, which includes a uniform resource locator, announcing the general concept of shoe sales to the customer's smartphone 102 because the customer's smartphone 102 was identified by an in-store beacon located in the store's shoe department. Continuing this example, the marketing system 108 also sends a message, which includes the same uniform resource locator, announcing the same general concept of shoe sales to the customer's wife's smartphone based on data that identifies the customer's wife and the customer's wife's previously expressed interest in buying shoes. Further to this example, the marketing system 108 also sends a message, which includes a different uniform resource locator, announcing the general concept of apparel sales to the customer's daughter's smartphone based on data that identifies the customer's daughter, the customer's daughter's previously expressed interest in buying apparel, and the customer's daughter's previously expressed lack of interest in buying shoes.

One possible algorithm for generating a uniform resource locator is to add a unique, randomly generated, combination of alphanumeric characters to the existing uniform resource locator for a marketer. An example of such a unique uniform resource locator is www.retailer.com/GH6%N*, where the characters “GH6%N*” will correspond uniquely to the marketing content which may be developed for a particular customer. A different uniform resource locator is generated for each marketing strategy, and each uniform resource locator will lead to unique marketing content that will be generated for a particular customer upon the customer's selection of the uniform resource locator. The marketer-developed marketing strategies associate the uniform resource locators with the communication channels. For example, marketing strategies may result in sending the general concept of store sales messages to communication devices identified by: an in-store beacon, a location within a store's geo-fence, an access of the store's Wi-Fi network, a receipt in the store of a push notification, an execution in the store of a mobile application, a participation in an augmented reality in the store, and an execution of a local search within a proximity of the store. In another example, marketing strategies may result in sending product-specific sales messages to communication devices identified by a scan of a QR code or a UPC code for the same type of product, and to communication devices identified as responding to a SMS message from the marketer about the product, a MMS message from the marketer about the product, or an email from the marketer about the product. In another example, marketing strategies may result in sending product-specific sales messages to communication devices identified by product-specific in-store sales beacons in the same department store, such as sending general shoe sales messages to communication devices identified by a shoe department's in-store beacon, and then sending general apparel sales messages to the same communication devices which are subsequently identified by an apparel department's in-store beacon in the same department store.

The marketing system 108 generates customized marketing content based on data which includes the identity of the user associated with the communication device, in response to receiving a selection of the uniform resource locator by the communication device. In embodiments, this may include the marketing system 108 generating customized sales offers for size 10 black shoes and warm socks that match brown shoes based on data that identifies the customer, identifies the customer's persisted interest in buying shoes, identifies the customer's previous purchase of size 10 brown shoes, and identifies the weather forecast for the customer's geographic location as becoming drastically colder, after the customer used the customer's smartphone 102 to select the uniform resource locator in the message about general shoe sales.

When a selection of the uniform resource locator is received, the marketing rules module 122 checks the marketing rules to apply them to relevant offers and other business objects. The recommendation engine 118 retrieves the relevant offers and customer relevant information from the database 124, and retrieves predictive models and their metadata from the model database 144. The model manager 120 determines the top offers based on the likelihood of every eligible relevant offer, and the recommendation engine 118 generates the customized marketing content for the customer.

The customized marketing content for each customer can include a customized set of offers or coupons or information regarding products and/or services that the recommendation engine 118 has concluded would be of interest to the customer based on various factors and data. Other examples of data that may be used to generate customized marketing content include information associated with the user based on demographic data, marketer information, a transaction history, a profile, a communication channel, a preference for a category associated with marketing content, an interaction history, a numbers of sales advertisement shared, a number of sales advertisement opened, a number of sales advertisement saved, a last transaction, the weather, a social media profile, a distance to seller of a product and/or a service, a distance to a competitor seller of a product and/or a service, a time, a day, a holiday, and/or a social media sentiment. Using the above-described data, the recommendation engine 118 customizes an offer or offers for the customer to identify specific products, discounts, dates, and conditions for any offers that are likely to appeal to him or her.

In another example, the marketing system 108 generates a customized sales offer for the latest style of women's shoes based on data that identifies the customer's wife, identifies the customer's wife's previously expressed interest in buying shoes, and demographic data that identifies the customer's wife as a female between the ages of 20 and 30. In yet another example, the marketing system 108 generates a customized sales offer for the latest style of teen dresses based on data that identifies the customer's daughter, identifies the customer's daughter's previously expressed interest in buying apparel, and social network data that identifies the customer's daughter as a female in her teens who indicated favorable sentiments when the daughter's social network friends posted photos of themselves while wearing the latest styles of teen dresses.

Prior art systems generate customized marketing content for a customer before the customer selects the uniform resource locator to access the previously generated customized marketing content. In contrast, the marketing system 108 functions more efficiently than prior art systems by selectively spending system resources such as time and computing capacity to generate customized marketing content only for customers who have already selected the corresponding uniform resource locator, while conserving system resources by not generating customized marketing content for customers who have yet to select their corresponding uniform resource locators. For example, if a prior art system sends general offer messages with their uniform resource locators to ten customers identified by a store's geo-fence, the prior art system has already spent system resources generating the customized offer details for all ten of the customers, even though only one of the ten customers subsequently selects the uniform resource locater in their general offer message. In contrast, the marketing system 108 sends general offer messages with the same uniform resource locator to ten customers identified by a store's geo-fence, and conserves system resources by generating the customized offer details for only the one customer who subsequently selects the uniform resource locater in their general offer message. In this example, the marketing system 108 conserves system resources by not generating any customized marketing content for the nine customers who do not select the uniform resource locator in their general offer messages.

The marketing system 108 sends the customized marketing content to the communication device. For example and without limitation, this may include the marketing system 108 sending the customized sales offers for size ten black shoes and warm socks that match brown shoes to the customer's smartphone 102. After selecting the uniform resource locator, a customer can access the customized marketing content that is selectively generated, in real time, for him or her. The customer can respond to the customized marketing content in many different ways. For example, the customer can indicate that he or she likes or dislikes the offer, can save the offer for future use, can share the offer with other communication device users via email, text messaging, and/or a social network, and can email the offer to herself/himself. The customer can view saved offers. The marketing system 108 persists customer's responses to improve the recommendations of offers to send to the customer in the future, such as saving customer's selection of marketing interest categories and saving customer's responses to offers.

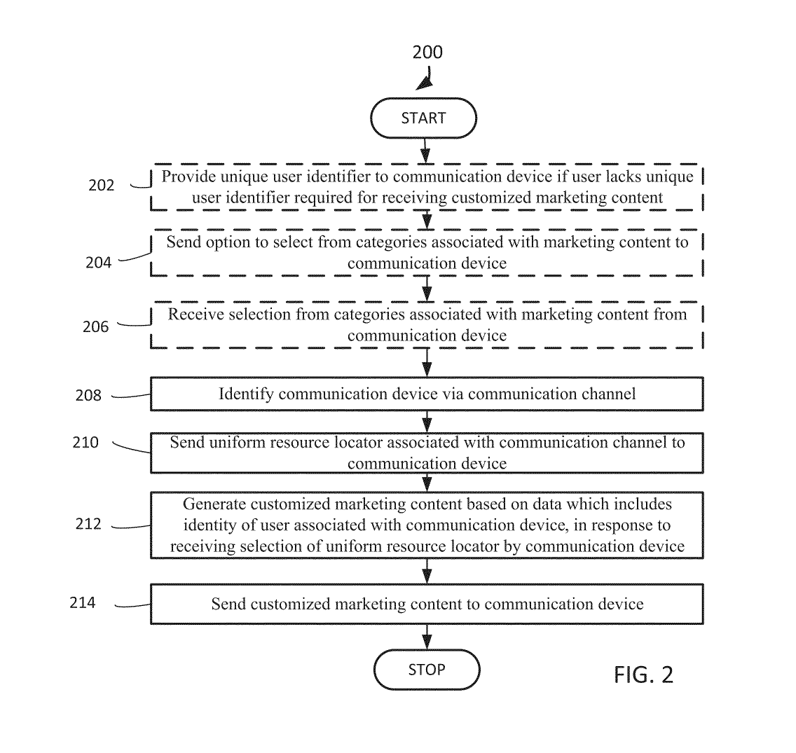

FIG. 2 is a flowchart that illustrates a computer-implemented method for selectively generating customized marketing content, under an embodiment. Flowchart 200 illustrates method acts illustrated as flowchart blocks for certain actions involved in and/or between the system elements 102-108 of FIG. 2.

A unique user identifier is optionally provided to a communication device if a user f the communication device lacks the unique user identifier required for receiving customized marketing content, block 202. For example and without limitation, this may include the marketing system 108 providing a unique user identifier to the customer's smartphone 102 because the customer's smartphone 102 is not registered yet to receive customized marketing content.

Having possibly initialized a communication device to receive customized marketing content, an option to select from categories associated with marketing content is optionally sent to the communication device, block 204. By way of example and without limitation, this may include the marketing system 108 providing marketing interest categories to the customer's smartphone 102 from which the customer can select, such as selecting from an interest in buying shoes and an interest in purchasing apparel.

If an option to select from marketing content categories is sent to a communication device, selection from the categories associated with the marketing content is optionally received from the communication device, block 206. In embodiments, this may include the marketing system 108 receiving the selection of shoes as a category of interest from the customer's smartphone 102

Having possibly initialized a communication device and a user's selection of marketing content categories, the communication device is identified via a communication channel, block 208. For example and without limitation, this may include the marketing system 108 identifying the customer's smartphone 102 in a store via an in-store beacon.

After identifying a communication device, a uniform resource locator associated with a communication channel is sent to the communication device, block 210. By way of example and without limitation, this may include the marketing system 108 sending a message, which includes a uniform resource locator, generally announcing store sales to the customer's smartphone 102.

After sending a uniform resource locator to a communication device, customized marketing content is generated based on data which includes the identity of the user associated with the communication device, after receiving a selection of the uniform resource locator by the communication device, block 212. In embodiments, this may include the marketing system 108 generating a customized sales offer for shoes based on data that identifies the customer and the customer's previously expressed interest in buying shoes, after the customer used the customer's smartphone 102 to select the uniform resource locator in the general message about store sales.

After generating customized marketing content, the customized marketing content is sent to the communication device, block 214. For example and without limitation, this may include the marketing system 108 sending the customized sales offer for shoes to the customer's smartphone 102.

Although FIG. 2 depicts the blocks 202-214 occurring in a specific order, the blocks 202-214 may occur in another order. In other implementations, each of the blocks 202-214 may also be executed in combination with other blocks and/or some blocks may be divided into a different set of blocks.

An exemplary hardware device in which the subject matter may be implemented shall be described. Those of ordinary skill in the art will appreciate that the elements illustrated in FIG. 3 may vary depending on the system implementation. With reference to FIG. 3, an exemplary system for implementing the subject matter disclosed herein includes a hardware device 300, including a processing unit 302, a memory 304, a storage 306, a data entry module 308, a display adapter 310, a communication interface 312, and a bus 314 that couples elements 304-312 to the processing unit 302.

The bus 314 may comprise any type of bus architecture. Examples include a memory bus, a peripheral bus, a local bus, etc. The processing unit 302 is an instruction execution machine, apparatus, or device and may comprise a microprocessor, a digital signal processor, a graphics processing unit, an application specific integrated circuit (ASIC), a field programmable gate array (FPGA), etc. The processing unit 302 may be configured to execute program instructions stored in the memory 304 and/or the storage 306 and/or received via the data entry module 308.

The memory 304 may include a read only memory (ROM) 316 and a random access memory (RAM) 318. The memory 304 may be configured to store program instructions and data during operation of the hardware device 300. In various embodiments, the memory 304 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. The memory 304 may also include nonvolatile memory technologies such as nonvolatile flash RAM (NVRAM) or ROM. In some embodiments, it is contemplated that the memory 304 may include a combination of technologies such as the foregoing, as well as other technologies not specifically mentioned. When the subject matter is implemented in a computer system, a basic input/output system (BIOS) 320, containing the basic routines that help to transfer information between elements within the computer system, such as during start-up, is stored in the ROM 316.

The storage 306 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 300.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which may store data that is accessible by a computer, such as magnetic cassettes, flash memory cards, digital video disks, Bernoulli cartridges, RAM, ROM, and the like may also be used in the exemplary operating environment. As used here, a “computer-readable medium” may include one or more of any suitable media for storing the executable instructions of a computer program in one or more of an electronic, magnetic, optical, and electromagnetic format, such that the instruction execution machine, system, apparatus, or device may read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 306, the ROM 316 or the RAM 318, including an operating system 322, one or more applications programs 324, program data 326, and other program modules 328. A user may enter commands and information into the hardware device 300 through data entry module 308. The data entry module 308 may include mechanisms such as a keyboard, a touch screen, a pointing device, etc. Other external input devices (not shown) are connected to the hardware device 300 via an external data entry interface 330. By way of example and not limitation, external input devices may include a microphone, joystick, game pad, satellite dish, scanner, or the like. In some embodiments, external input devices may include video or audio input devices such as a video camera, a still camera, etc. The data entry module 308 may be configured to receive input from one or more users of the hardware device 300 and to deliver such input to the processing unit 302 and/or the memory 304 via the bus 314.

A display 332 is also connected to the bus 314 via the display adapter 310. The display 332 may be configured to display output of the hardware device 300 to one or more users. In some embodiments, a given device such as a touch screen, for example, may function as both the data entry module 308 and the display 332. External display devices may also be connected to the bus 314 via the external display interface 334. Other peripheral output devices, not shown, such as speakers and printers, may be connected to the hardware device 300.

The hardware device 300 may operate in a networked environment using logical connections to one or more remote nodes (not shown) via the communication interface 312. The remote node may be another computer, a server, a router, a peer device or other common network node, and typically includes many or all of the elements described above relative to the hardware device 300. The communication interface 312 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 312 may include logic configured to support direct memory access (DMA) transfers between the memory 304 and other devices.

In a networked environment, program modules depicted relative to the hardware device 300, or portions thereof, may be stored in a remote storage device, such as, for example, on a server. It will be appreciated that other hardware and/or software to establish a communications link between the hardware device 300 and other devices may be used.

It should be understood that the arrangement of the hardware device 300 illustrated in FIG. 3 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 300.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 3.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter may also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for selectively generating customized marketing content, the system comprising:
one or more processors; and
a non-transitory computer readable medium storing a plurality of instructions, which when executed, cause the one or more processors to:
identify a communication device via a communication channel;
send a uniform resource locator associated with the communication channel to the communication device;
generate customized marketing content based on data comprising an identity of a user associated with the communication device, in response to receiving a selection of the uniform resource locator by the communication device; and
send the customized marketing content to the communication device.

2. The system of claim 1, wherein the communication channel is associated with at least one of an access via a mobile web site, a transmission from an in-store beacon, a Short Message Service (SMS) message from a marketer, a Multimedia Messaging Service (MMS) message from a marketer, a view of an advertisement, a location within a geo-fence, a receipt of a push notification, an execution of a mobile application, a receipt of an email from a marketer, an execution of a local search, a participation in an augmented reality, a scan of a Quick Response (QR) code, a scan of a Universal Product Code (UPC), and an access of a Wi-Fi network.

3. The system of claim 1, wherein the uniform resource locator comprises one of a plurality of uniform resource locators, the communication channel comprises one of a plurality of communication channels, and a plurality of marketing strategies associate the plurality of uniform resource locators with the plurality of communication channels.

4. The system of claim 1, wherein the customized marketing content comprises at least one sales advertisement for at least one of a product and a service.

5. The system of claim 1, wherein the data further comprises information associated with the user based on at least one of demographic data, marketer information, a transaction history, a profile, a communication channel, a preference for a category associated with marketing content, an interaction history, a numbers of sales advertisement shared, a number of sales advertisement opened, a number of sales advertisement saved, a last transaction, weather, a social media profile, a distance to seller of at least one of a product and a service, a distance to a competitor seller of at least one of a product and a service, a time, a day, a holiday, and a social media sentiment.

6. The system of claim 1, wherein the plurality of instructions, when executed, will further cause the one or more processors to provide a unique user identifier to the communication device in response to a determination that the user lacks the unique user identifier required for receiving customized marketing content.

7. The system of claim 1, wherein the plurality of instructions, when executed, will further cause the one or more processors to:
send an option to select from a plurality of categories associated with a plurality of marketing content to the communication device; and
receive a selection from the plurality of categories associated with the plurality of marketing content from the communication device.

8. A computer-implemented method for selectively generating customized marketing content, the method comprising:
identifying a communication device via a communication channel;
sending a uniform resource locator associated with the communication channel to the communication device;
generating customized marketing content based on data comprising an identity of a user associated with the communication device, in response to receiving a selection of the uniform resource locator by the communication device; and
sending the customized marketing content to the communication device.

9. The computer-implemented method of claim 8, wherein the communication channel is associated with at least one of an access via a mobile web site, a transmission from an in-store beacon, a Short Message Service (SMS) message from a marketer, a Multimedia Messaging Service (MMS) message from a marketer, a view of an advertisement, a location within a geo-fence, a receipt of a push notification, an execution of a mobile application, a receipt of an email from a marketer, an execution of a local search, a participation in an augmented reality, a scan of a Quick Response (QR) code, a scan of a Universal Product Code (UPC), and an access of a Wi-Fi network.

10. The computer-implemented method of claim 8, wherein the uniform resource locator comprises one of a plurality of uniform resource locators, the communication channel comprises one of a plurality of communication channels, and a plurality of marketing strategies associate the plurality of uniform resource locators with the plurality of communication channels.

11. The computer-implemented method of claim 8, wherein the customized marketing content comprises at least one sales advertisement for at least one of a product and a service.

12. The computer-implemented method of claim 8, wherein the data further comprises information associated with the user based on at least one of demographic data, marketer information, a transaction history, a profile, a communication channel, a preference for a category associated with marketing content, an interaction history, a numbers of sales advertisement shared, a number of sales advertisement opened, a number of sales advertisement saved, a last transaction, weather, a social media profile, a distance to seller of at least one of a product and a service, a distance to a competitor seller of at least one of a product and a service, a time, a day, a holiday, and a social media sentiment.

13. The computer-implemented method of claim 8, wherein the method further comprises
providing a unique user identifier to the communication device in response to a determination that the user lacks the unique user identifier required for receiving customized marketing content;
sending an option to select from a plurality of categories associated with a plurality of marketing content to the communication device; and
receiving a selection from the plurality of categories associated with the plurality of marketing content from the communication device.

14. A computer program product, comprising a non-transitory computer-readable medium having a computer-readable program code embodied therein to be executed by one or more processors, the program code including instructions to:
identify a communication device via a communication channel;
send a uniform resource locator associated with the communication channel to the communication device;
generate customized marketing content based on data comprising an identity of a user associated with the communication device, in response to receiving a selection of the uniform resource locator by the communication device; and
send the customized marketing content to the communication device.

15. The computer program product of claim 14, wherein the communication channel is associated with at least one of an access via a mobile web site, a transmission from an in-store beacon, a Short Message Service (SMS) message from a marketer, a Multimedia Messaging Service (MMS) message from a marketer, a view of an advertisement, a location within a geo-fence, a receipt of a push notification, an execution of a mobile application, a receipt of an email from a marketer, an execution of a local search, a participation in an augmented reality, a scan of a Quick Response (QR) code, a scan of a Universal Product Code (UPC), and an access of a Wi-Fi network.

16. The computer program product of claim 14, wherein the uniform resource locator comprises one of a plurality of uniform resource locators, the communication channel comprises one of a plurality of communication channels, and a plurality of marketing strategies associate the plurality of uniform resource locators with the plurality of communication channels.

17. The computer program product of claim 14, wherein the customized marketing content comprises at least one sales advertisement for at least one of a product and a service.

18. The computer program product of claim 14, wherein the data further comprises information associated with the user based on at least one of demographic data, marketer information, a transaction history, a profile, a communication channel, a preference for a category associated with marketing content, an interaction history, a numbers of sales advertisement shared, a number of sales advertisement opened, a number of sales advertisement saved, a last transaction, weather, a social media profile, a distance to seller of at least one of a product and a service, a distance to a competitor seller of at least one of a product and a service, a time, a day, a holiday, and a social media sentiment.

19. The computer program product of claim 14, wherein the program code includes further instructions to provide a unique user identifier to the communication device in response to a determination that the user lacks the unique user identifier required for receiving customized marketing content.

20. The computer program product of claim 14, wherein the program code includes further instructions to:
send an option to select from a plurality of categories associated with a plurality of marketing content to the communication device; and
receive a selection from the plurality of categories associated with the plurality of marketing content from the communication device.
